(19) United States
(12) Patent Application Publication
(10) Pub. No.: US 2014/0198483 A1
(43) Pub. Date: Jul. 17, 2014

(54) DIFFUSION PLATE AND DIRECT TYPE BACKLIGHT MODULE HAVING SAME

(71) Applicant: Hon Hai Precision Industry Co., Ltd., New Taipei (TW)

(72) Inventor: LI-YING WANG HE, New Taipei (TW)

(73) Assignee: HON HAI PRECISION INDUSTRY CO., LTD., New Taipei (TW)

(21) Appl. No.: 14/109,902

(22) Filed: Dec. 17, 2013

(30) Foreign Application Priority Data
Jan. 17, 2013 (TW) 102101758

(51) Int. Cl. F21V 5/04; F21V 13/02

(52) U.S. Cl. CPC F21V 5/045; F21V 13/02
USPC 362/97.1; 362/326

(57) ABSTRACT

A diffusion plate includes a substrate. The substrate has a light entrance surface, and a light emitting surface facing away from the light entrance surface. The diffusion plate also includes a plurality of Fresnel lenses. The Fresnel lenses are formed at the light emitting surface, and an ultraviolet absorbent layer is formed at the light entrance surface.

### BACKGROUND

1. Technical Field

The present disclosure generally relates to diffusion plates and backlight modules, and particularly, relates to a diffusion plate used in a direct type backlight module, and a backlight module having the diffusion plate.

2. Description of Related Art

As a light source, a backlight module usually supplies a light for meters, display devices, and other electronic devices.

A typical direct type backlight module includes a number of light sources, and a diffusion plate facing to the light sources. The diffusion plate is a double-layer structure having a transparent substrate and a diffusion film formed on the transparent substrate. However, because the diffusion plate only processes a light diffusion by the diffusion film, the diffusion plate has a poor light diffusion, and a degree of homogeneity of the diffusion plate is lower. Accordingly, the backlight module having the diffusion plate has a poor light uniformity.

What is needed, therefore, is a diffusion plate and a backlight module to overcome the above-described problems.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 shows a direct type backlight module according to a first embodiment.

FIG. 2 shows a diffusion plate of the direct type backlight module of FIG. 1.

FIG. 3 shows a direct type backlight module according to a second embodiment.

FIG. 4 shows a direct type backlight module according to a third embodiment.

FIG. 5 is an enlarged view of a circled part V of FIG. 4.

### DETAILED DESCRIPTION

Embodiments will now be described in detail with reference to the drawings.

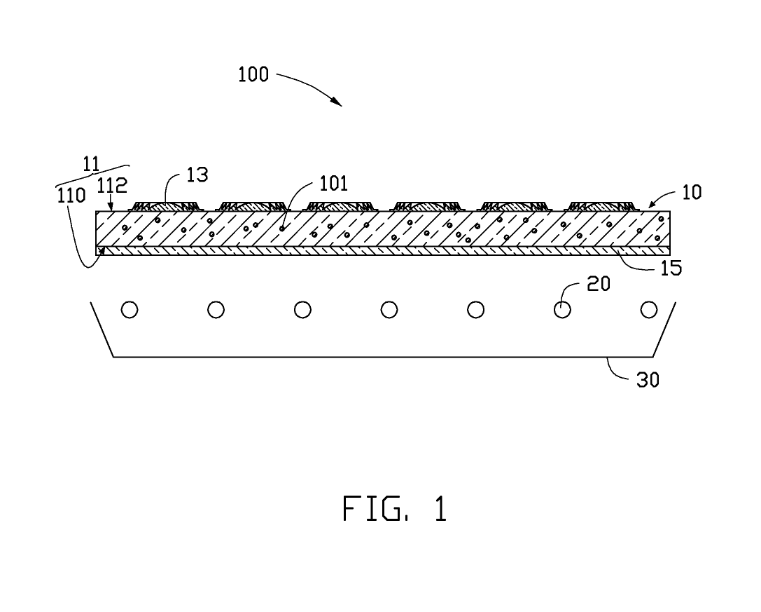

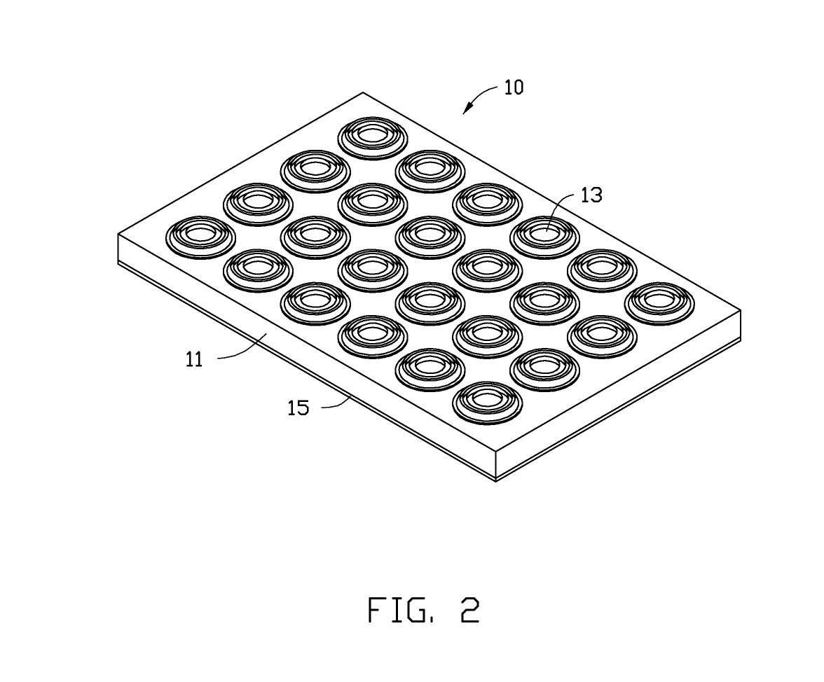

FIGS. 1-2 show a direct type backlight module 100 according to a first embodiment. The direct type backlight module 100 includes a diffusion plate 10, a plurality of light sources 20, and a reflection plate 30.

The diffusion plate 10 is arranged over the light sources 20. That is, the diffusion plate 10 faces to the light sources 20, and includes a substrate 11, and a plurality of Fresnel lenses 13.

The substrate 11 is made of a light transparent material, and has a light entrance surface 110, and a light emitting surface 112 facing away from the light entrance surface 110. The material of the substrate 11 may be polycarbonate, polymethylmethacrylate, methyl methacrylate, styrene copolymers, polystyrene, or a compound comprised of two or more described materials. There are many light diffusion particles 101 for diffusing a light entering into the substrate 11 from the light entrance surface 110. The material of the light diffusion particle 101 may be silicon, silicon dioxide, titanium dioxide, polymethylmethacrylate, methyl methacrylate, styrene copolymers, polystyrene, or a compound comprised of two or more described materials.

The Fresnel lenses 13 are arranged on the light emitting surface 112, and are configure for re-diffusing the light emitted from the light emitting surface 112 to improve a diffusion efficiency of the diffusion plate 10. In the present embodiment, the Fresnel lenses 13 are arranged in an array.

The light sources 20 are arranged between the diffusion plate 10 and the reflection plate 30, and are configured for emitting light to the diffusion plate 10.

The reflection plate 30 is arranged blow the light sources 20. That is, the reflection plate 30 faces the light sources 20. The reflection plate 30 reflects the light from the light sources 20 to the diffusion plate 10 to improve the utilization rate of light.

In the present embodiment, in order to prevent a crackle or an etiolation caused by a damaged molecular structure of diffusion plate, which is caused by an irradiation of the ultraviolet rays in the light from the light sources 20, occurring, there is an ultraviolet absorbent layer 15 formed on the light entrance surface 110. The ultraviolet absorbent layer 15 includes an ultraviolet absorbent, for example, two department of benzophenone ultraviolet absorbent, three Triazine series ultraviolet absorbent, benzene and three azoles ultraviolet absorbent, cyclic iminoester based ultraviolet absorbent, or a compound comprised of two or more described kinds.

The light emitted from the light sources 20 first passes through the diffusion plate 10, and then is diffused by the light diffusion particles 101 in the substrate 11. The diffused light is re-diffused by the Fresnel lenses 13. That is, the light emitted from the light sources 20 is diffused twice, such that the diffusivity of the light passing through the diffusion plate 10 is improved, and the light passing through the diffusion plate 10 is more uniform. The light from the direct type backlight module 100, having the diffusion plate 10, is more uniform.

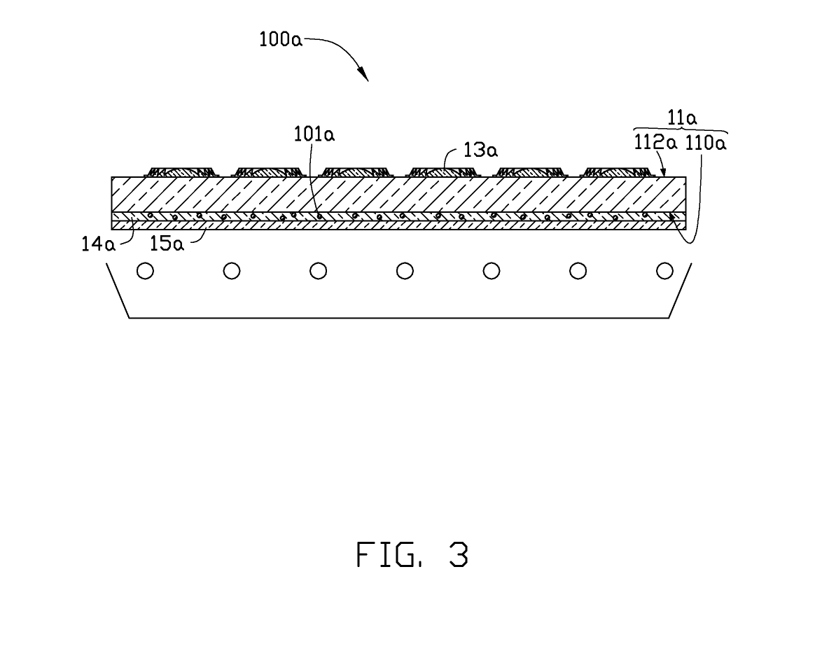

FIG. 3 shows a direct type backlight module 100a according to a second embodiment. The direct type backlight module 100a includes a diffusion plate 10a. The diffusion plate 10a is similar to the diffusion plate 10, and includes a substrate 11a, a plurality of Fresnel lenses 13a, and a light diffusion layer 14a. The substrate 11a is similar to the substrate 11, and has a light entrance surface 110a, and a light emitting surface 112a facing away from the light entrance surface 110a. The light diffusion layer 14a is configured for firstly diffusing the light entering into the diffusion plate 10a. The light diffusion layer 14a is a mixing layer comprised of a transparent material 141a and a plurality of light diffusion particles 101a. A transparent material 141a is similar to or identical with the material of the substrate 11. A material of the light diffusion particles 101a is similar to or identical with the material of the light diffusion particles 101. The Fresnel lenses 13a are arranged on the light emitting surface 112a, and are configured for re-diffusing the light from the light emitting surface 112a to improve the diffusivity of the diffusion plate 10a.

In order to prevent a crackle or an etiolation caused by a damaged molecular structure of diffusion plate 10a, which is caused by an irradiation of the ultraviolet rays in the light from the light sources, occurring, there is a ultraviolet absorbent layer 15a formed on the light entrance surface 110a.

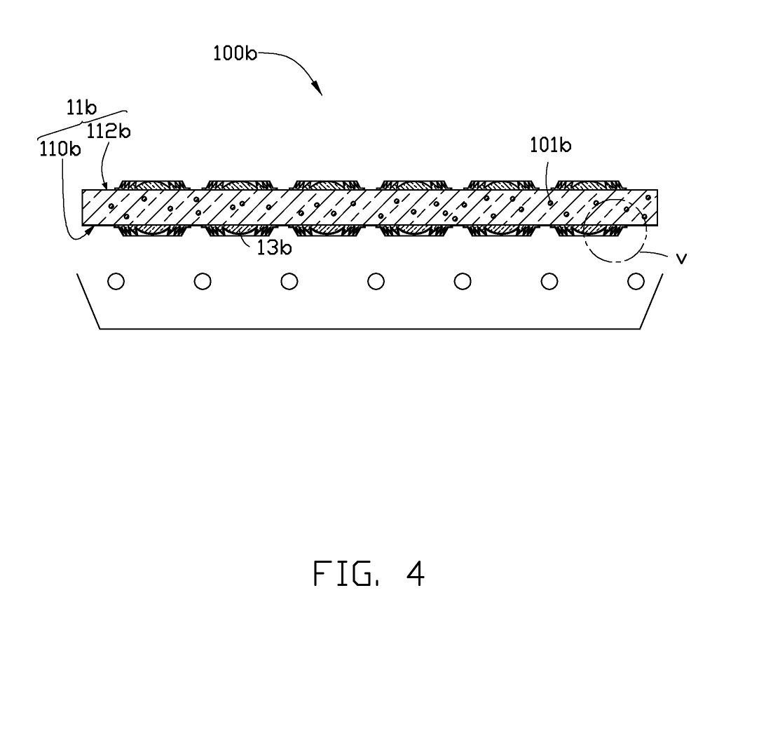

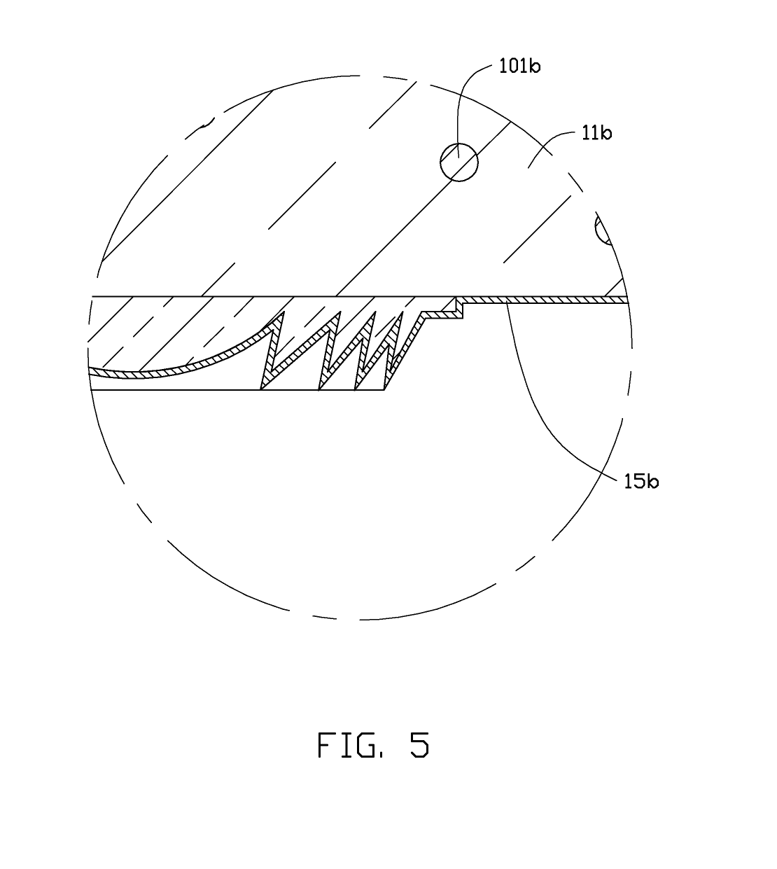

FIGS. 4 and 5 show a direct type backlight module 100b according to a third embodiment. The direct type backlight module 100b includes a diffusion plate 10b. The diffusion plate 10b includes a substrate 11b having a plurality of light diffusion particles 101b, and a plurality of Fresnel lenses 13b. A number of the Fresnel lenses 13b are formed at the light entrance surface 110b of the substrate 11b, and the other Fresnel lenses 13b are formed at the light emitting surface 112b of the substrate 11b. An ultraviolet absorbent layer 15b is formed at a surface of the light entrance surface 110b exposed from the Fresnel lenses 13b, and the surfaces of the Fresnel lenses 13b on the light entrance surface 110b.

While certain embodiments have been described and exemplified above, various other embodiments will be apparent from the foregoing disclosure to those skilled in the art. The disclosure is not limited to the particular embodiments described and exemplified but is capable of considerable variation and modification without departure from the scope and spirit of the appended claims.

What is claimed is:

1. A diffusion plate comprising a substrate, the substrate having a light entrance surface, and a light emitting surface facing away from the light entrance surface, wherein the diffusion plate further comprises a plurality of Fresnel lenses, the Fresnel lenses are formed at the light emitting surface, and an ultraviolet absorbent layer is formed at the light entrance surface.

2. The diffusion plate of claim 1, wherein a plurality of light diffusion particles are dispersed in the substrate.

3. The diffusion plate of claim 1, wherein a light diffusion layer is formed at the light entrance surface, and the light diffusion layer is sandwiched between the ultraviolet absorbent layer and the light entrance surface.

4. The diffusion plate of claim 3, wherein a plurality of light diffusion particles are dispersed in light diffusion layer.

5. The diffusion plate of claim 1, wherein the Fresnel lenses are arranged in an array.

6. A diffusion plate comprising a substrate, the substrate having a light entrance surface, and a light emitting surface facing away from the light entrance surface, wherein the diffusion plate further comprises a plurality of Fresnel lenses, the Fresnel lenses are formed at the light entrance surface, and an ultraviolet absorbent layer is formed at a part of surface of the light entrance surface exposed to the outside from the Fresnel lenses.

7. The diffusion plate of claim 6, wherein a plurality of the other Fresnel lenses are formed at the light emitting surface.

8. The diffusion plate of claim 6, wherein a plurality of light diffusion particles are dispersed in the substrate.

9. The diffusion plate of claim 6, wherein the Fresnel lenses formed at the light entrance surface are arranged in an array.

10. A direct type backlight module comprising a diffusion plate and a plurality of light sources, the substrate having a light entrance surface, and a light emitting surface facing away from the light entrance surface, the light sources facing to the light entrance surface, wherein the diffusion plate further comprises a plurality of Fresnel lenses, the Fresnel lenses are formed at the light emitting surface, and an ultraviolet absorbent layer is formed at the light entrance surface.

11. The direct type backlight module of claim 10, wherein a plurality of light diffusion particles are dispersed in the substrate.

12. The direct type backlight module of claim 10, wherein a light diffusion layer is formed at the light entrance surface, and the light diffusion layer is sandwiched between the ultraviolet absorbent layer and the light entrance surface.

13. The direct type backlight module of claim 12, wherein a plurality of light diffusion particles are dispersed in light diffusion layer.

14. The direct type backlight module of claim 10, wherein the Fresnel lenses are arranged in an array.
